(19) United States
(12) Patent Application Publication
(10) Pub. No.: US 2019/0297922 A1
(43) Pub. Date: Oct. 3, 2019

(54) Microwave-Heating System, Microwave-Heating Process, and Process for Manufacturing Packaged Foods

(71) Applicant: MORINAGA MILK INDUSTRY CO., LTD., Tokyo (JP)

(72) Inventors: Yasuhiro Takeda, Kanagawa (JP); Atsushi Furuya, Kanagawa (JP); Takahiro Koyama, Kanagawa (JP); Hiroyuki Ikeda, Kanagawa (JP); Junichi Otsuji, Tokyo (JP); Shuji Obi, Tokyo (JP); Yasuji Yamamoto, Osaka (JP); Junichi Kodama, Osaka (JP)

(73) Assignee: MORINAGA MILK INDUSTRY CO., LTD., Tokyo (JP)

(21) Appl. No.: 16/299,569

(22) Filed: Mar. 12, 2019

(30) Foreign Application Priority Data
Mar. 30, 2018 (JP) 2018-067684

(51) Int. Cl. A23L 3/01; H01P 3/12; H01P 1/02; H05B 6/68; A23L 3/04; A23L 3/00; A23L 3/015; B65B 55/02

(52) U.S. Cl. CPC A23L 3/01; H01P 3/12; H01P 1/022; H05B 6/68; A23V 2002/00; A23L 3/001; A23L 3/015; B65B 55/02; A23L 3/04

(57) ABSTRACT

A microwave-heating system irradiates sealed packaged foods with microwaves to heat the packaged foods at 100° C. or higher for heat sterilization. The microwave-heating system includes a microwave generator to irradiate the packaged foods with microwaves of 2450 MHz in a multi-mode and a microwave generator to irradiate the packaged foods in a waveguide with microwaves of 915 MHz in a single-mode.

This application claims priority under 35 U.S.C. § 119 to Japanese Patent App. No. 2018-067684, filed 30 Mar. 2018, the entirety of which is incorporated by reference herein.

### BACKGROUND

### Field of Endeavor

The present invention relates to microwave-heating systems to irradiate sealed packaged foods with microwaves for heating, such a microwave-heating process, and processes for manufacturing packaged foods by such a system.

### Brief Description of the Related Art

Conventional processes of packaged foods, such as retort foods, externally heats the foods for sterilization. Such a process has problems due to the long-duration of heating, including deterioration of the food's freshness and deterioration of the food's quality in nutrients, flavor, and color. Considering these problems, a heat sterilization system by dielectric heating with microwaves has been known recently to sterilize packaged foods in a short time. Microwaves enable internal heating of foods, and so good quality foods by sterilization can be expected. Microwaves have different depths of penetration into an article depending on the operating frequencies, and a technique has been proposed which heats an article with microwaves of a plurality of frequencies. Note here that the depth of penetration is a depth where the incident electric field intensity reduces to 1/e, and the depth of penetration corresponding to ½ of the incident electric field intensity is called a half power depth.

JP-A-1995-255388, for example, describes a heat sterilization system under pressure including first and second heating chambers that have a space wide enough for sealed packaged foods to be heated. The system conveys the foods along a conveyor line disposed in these heating chambers while applying microwaves of the frequency of 500 to 1000 MHz to the foods from a waveguide and next applying microwaves of the frequency of 1000 to 3000 MHz to heat the entire foods.

JP-A-2015-118781 describes a microwave-heating system that is a hybrid microwave oven. The system includes a 915-MHz magnetron and a 915-MHz waveguide as well as a 2450-MHz magnetron and a 2450-MHz waveguide and includes a metal heating box having a chamber that is wide enough to store an article. The metal heating box applies the transmitted 915-MHz microwaves and 2450-MHz microwaves to the article. Note here that water at 25° C. has a half power depth of 9 cm at 915 MHz and 1.3 cm at 2450 MHz, and water at 85° C. has a half power depth of 24 cm at 915 MHz and 3.9 cm at 2450 MHz.

These microwave-heating systems described in JP-A-1995-255388 and JP-A-2015-118781 are configured to apply microwaves with two levels of higher and lower frequency having different half power depths so as to heat the entire article uniformly. The heating with microwaves in these systems is of a multi-mode where microwaves from each waveguide are multiple reflected in the chamber, and so has a problem that the chamber to store a waveguide for the low frequency range is large. Heating in such a multi-mode has a certain limit of the efficiency. The system of JP-A-2015-118781 has a difficulty of requiring a large metal heating box, and so this system has a limit in business use requiring high throughput.

### SUMMARY

One aspect of the present invention includes a microwave-heating system that heats an article with microwaves of a high frequency range in a multi-mode and heats the article with microwaves of a low frequency range in a single-mode, and provides such a process. It also provides process for manufacturing packaged foods by such a microwave-heating system.

Another aspect of the present invention includes irradiating a sealed packaged article with microwaves of a first frequency in a multi-mode and irradiating the sealed packaged article with microwaves of a second frequency lower than the first frequency in a single-mode. Such irradiation with microwaves of the first and the second frequency rapidly heat different parts of the article corresponding to the different half power depths, and so implements uniform heating of the entire article without undesirable temperature distribution. The single-mode irradiation with microwaves of the second frequency having a longer wavelength in the waveguide makes the structure compact and efficient as compared with the structure in a multi-mode.

### BRIEF DESCRIPTION OF THE DRAWINGS

FIG. 1A is a schematic side view of one embodiment of a microwave-heating system according to the present invention.

FIG. 1B is a time chart showing a change in the inner temperature of the packaged foods during microwave-heating.

FIG. 2A shows the relationship between the frequency of microwaves and the half power depth when a sample is heated at high frequency.

FIG. 2B shows the relationship between the frequency of microwaves and the half power depth when a sample is heated at low frequency.

FIG. 2C shows the relationship between the frequency of microwaves and the half power depth when a sample is heated by applying both high and low frequency.

FIG. 3A is a plan view showing one example of the structure of a window to guide the waveguide into the pressure vessel.

FIG. 3B is a vertical cross-sectional view showing one example of the structure of a window to guide the waveguide into the pressure vessel.

FIG. 4A is a schematic side view of one example of the waveguide to transmit microwaves in the low frequency range.

FIG. 4B shows the Poynting vector in the TE10 mode as one example of the transmission mode to transmit microwaves in the low frequency range.

FIG. 4C shows one example of the waveguide to transmit microwaves in the low frequency range, showing FIG. 4A viewed from the left.

FIG. 4D shows one example of the structure of the waveguide to transmit microwaves in the low frequency range, and is a perspective view of the short-circuiting plate.

FIG. 5 is a schematic plan view of a rotary feeder that is one example of the feeder.

FIG. 6 is a block diagram showing one example of the microwave-heating system.

FIG. 7A to FIG. 7D show another example of the waveguide to transmit microwaves in the low frequency range:

FIG. 7A is a schematic perspective view of the waveguide as a part of the pressure vessel;

FIG. 7B shows one example of the structure of the window to guide the waveguide into the pressure vessel;

FIG. 7C is a view of the waveguide along the longitudinal direction; and

FIG. 7D is a view taken along the arrow C-C of FIG. 7A.

FIG. 8A to FIG. 8CC shows the test results indicating the relationship between large, medium and small dimensions of the long sides in the cross section of the waveguide at 915 MHz in the low frequency range, and the electric field intensity of standing waves when the waveguides do not have openings:

FIG. 8A shows the electric field intensity in the waveguide of 326 mm (corresponding to the free space wavelength λo);

FIG. 8AA shows the electric field intensity in the axial direction of the waveguide of FIG. 8A;

FIG. 8B shows the electric field intensity in the waveguide of 247.6 mm (corresponding to the intermediate standard “WRI-9” between λo/2 to λo);

FIG. 8BB shows the electric field intensity in the axial direction of the waveguide of FIG. 8B;

FIG. 8C shows the electric field intensity in the waveguide of 164 mm (corresponding to ½ of λo); and

FIG. 8CC shows the electric field intensity in the axial direction of the waveguide of FIG. 8C.

FIG. 9A to FIG. 9CC show the waveguides having large dimensions in the long-side direction of the cross section at 915 MHz in the low frequency range, and show the test results indicating the relationship between the dimension of the openings in that direction and the electric field intensity of standing waves:

FIG. 9A shows the electric field intensity in the waveguide with the opening of 125 mm;

FIG. 9AA shows the electric field intensity in the axial direction of the waveguide of FIG. 9A;

FIG. 9B shows the electric field intensity in the waveguide with the opening of 150 mm;

FIG. 9BB shows the electric field intensity in the axial direction of the waveguide of FIG. 9B;

FIG. 9C shows the electric field intensity in the waveguide with the opening of 165 mm; and

FIG. 9CC shows the electric field intensity in the axial direction of the waveguide of FIG. 9C.

FIG. 10A to FIG. 10CC and FIG. 11A to FIG. 11CC show the waveguides having middle dimensions in the long-side direction of the cross section at 915 MHz in the low frequency range, and show the test results indicating the relationship between the dimension of the openings in that direction and the electric field intensity of standing waves:

FIG. 10A shows the electric field intensity in the waveguide with the opening of 25 mm;

FIG. 10AA shows the electric field intensity in the axial direction of the waveguide of FIG. 10A;

FIG. 10B shows the electric field intensity in the waveguide with the opening of 50 mm;

FIG. 10BB shows the electric field intensity in the axial direction of the waveguide of FIG. 10B;

FIG. 10C shows the electric field intensity in the waveguide with the opening of 75 mm;

FIG. 10CC shows the electric field intensity in the axial direction of the waveguide of FIG. 10C;

FIG. 11A shows the electric field intensity in the waveguide with the opening of 100 mm;

FIG. 11AA shows the electric field intensity in the axial direction of the waveguide of FIG. 11A;

FIG. 11B shows the electric field intensity in the waveguide with the opening of 150 mm;

FIG. 11BB shows the electric field intensity in the axial direction of the waveguide of FIG. 11B;

FIG. 11C shows the electric field intensity in the waveguide with the opening of 165 mm; and

FIG. 11CC shows the electric field intensity in the axial direction of the waveguide of FIG. 11C.

FIG. 12A to FIG. 12CC show the waveguides having small dimensions in the long-side direction of the cross section at 915 MHz in the low frequency range, and show the test results indicating the relationship between the dimension of the openings in that direction and the electric field intensity of standing waves:

FIG. 12A shows the electric field intensity in the waveguide with the opening of 25 mm;

FIG. 12AA shows the electric field intensity in the axial direction of the waveguide of FIG. 12A;

FIG. 12B shows the electric field intensity in the waveguide with the opening of 150 mm;

FIG. 12BB shows the electric field intensity in the axial direction of the waveguide of FIG. 12B;

FIG. 12C shows the electric field intensity in the waveguide with the opening of 164 mm; and

FIG. 12CC shows the electric field intensity in the axial direction of the waveguide of FIG. 12C.

### DETAILED DESCRIPTION OF EXEMPLARY EMBODIMENTS

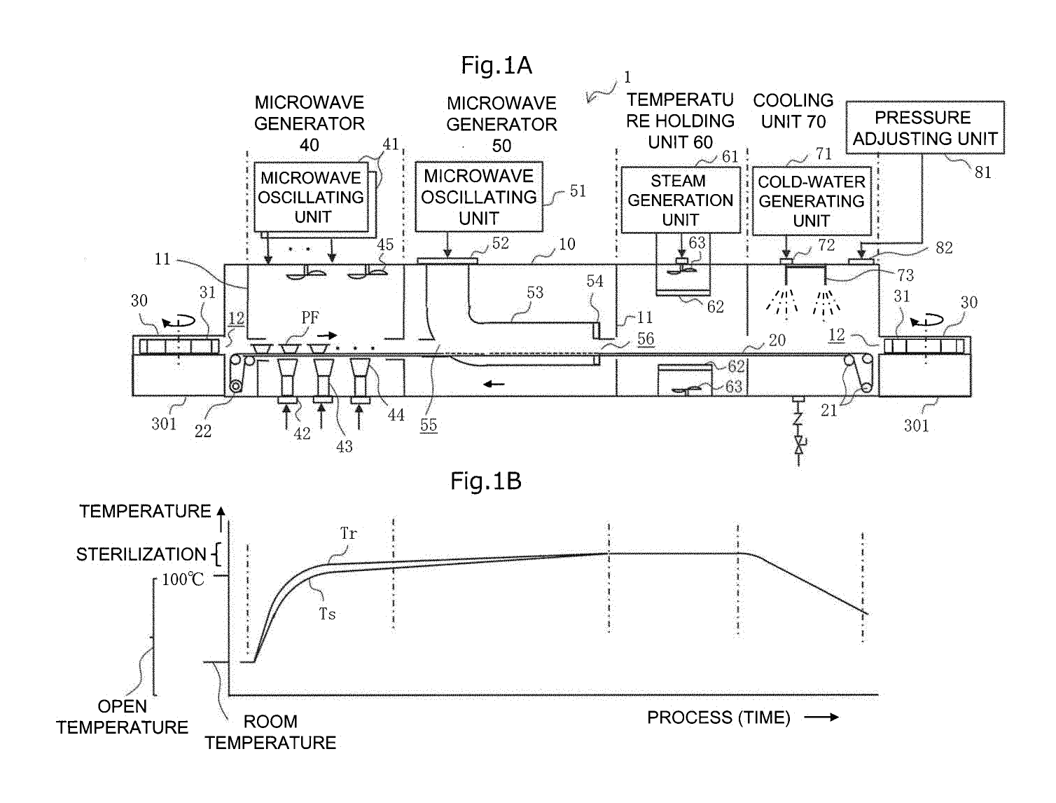

FIG. 1A is a schematic side view of one embodiment of a microwave-heating system according to principles of the present invention. The microwave-heating system 1 in FIG. 1A includes: a pressure vessel 10 to heat packaged foods PF as sealed packaged foods to be heated; and a feeder 30 that connects to the upstream end and the downstream end of the pressure vessel 10 that are on the left and the right, respectively, of FIG. 1A to load and unload the packaged foods PF.

The pressure vessel 10 has a tubular shape that is elongated in the conveying direction, e.g., a rectangular tubular shape, and is made of metal having pressure resistance to normal pressure or higher. To heat packaged foods PF, the inner temperature of the packaged foods PF needs to increase to 110° C. to 130° C. for reliable sterilization (to kill bacteria). Such heating evaporates the water inside of the foods in the normal-pressure space and so increases the pressure inside of the package, so that the package may rupture. To avoid breaking the package, heating is performed in a high pressure environment (for example, 0.13 MPa or higher for 123° C., e.g. 0.2 MPa) of the pressure vessel 10.

The pressure vessel 10 internally has a plurality of partition plates 11 along the conveying direction so as to define a plurality of chambers for a heat sterilization process that are substantially partitioned in the conveying direction. The pressure vessel 10 also has a conveying device along the conveying direction, e.g., a belt conveyor 20. Preferably the partition plates 11 are metal plates, and each have a window at a part in the height direction in the present embodiment so that packaged foods PF can pass through these windows.

The belt conveyor 20 extends over a plurality of rollers 21 while circling around the rollers along the conveying direction. One of the rollers 21 has a rotary shaft that extends to the outside of the pressure vessel 10, and this rotary shaft joins to (meshes with) the output shaft of a motor 22 as a driving unit for conveyance so as to receive rotary driving force from the outside.

The motor 22 conveys sealed packaged foods PF to be heated on the belt conveyor 20 at a predetermined speed or intermittently from the left to the right of FIG. 1A as shown by the arrow. Packaged foods PF are loaded via the upstream feeder 30, pass through the windows of the partition plates 11, and then are unloaded via the downstream feeder 30. Packaged foods PF each have a package made of a microwave-transmissive material, such as plastic, and the package is filled with foods. Various types of foods are currently available for packaged foods, and heat sterilization is performed to the foods after they are packaged as well as the container. The foods include solid foods, solid-liquid foods, high-viscosity foods, and paste foods. The packaged foods may have a headspace in the package.

The pressure vessel 10 includes the chambers of a microwave generator 40, a microwave generator 50, a temperature holding unit 60, and a cooling unit 70 that are disposed in sequence from the upstream end, and these chambers are substantially partitioned by the partition plates 11. The pressure vessel 10 has the required number of windows at appropriate positions to communicate with various external members as described later, and these windows serve as connectors to join the inside and the outside of the pressure vessel. FIG. 1A shows the microwave generator 40 at the most upstream end, and the pressure vessel may include a pre-heating unit at the loading area by the feeder 30. The pre-heating unit pre-heats articles to a predetermined temperature by a steam heater, for example.

As shown in FIG. 1B, the inner temperature of the packaged foods PF is controlled by the microwave generator 40 of a first frequency, the microwave generator 50 of a second frequency, the temperature holding unit 60, and the cooling unit 70. Specifically, the microwave generator 40 internally heats packaged foods PF so that the inner temperature of the packaged foods PF rapidly increases mainly at a part corresponding to the frequency of the microwaves from room temperatures to sterilization temperatures (110 to 130° C.). Next the microwave generator 50 heats the packaged foods PF mainly at another part corresponding to the frequency of the microwaves to sterilization temperatures. In FIG. 1B, Tr shows a temperature change at a part where the temperature increases rapidly, and Ts shows a temperature change at a part where the temperature increases slowly. Next the temperature holding unit 60 holds the temperature for a duration required for sterilization. Then the cooling unit 70 cools the inner temperature to less than 100° C. in a relatively short time so as not to break the package when the packaged foods are unloaded to the outside.

The microwave generator 40 applies microwaves of the first frequency, e.g., 2450 MHz, to the packaged foods PF. The microwave generator 40 at least includes: an oscillator to oscillate microwaves of 2450 MHz, e.g., a plurality of microwave oscillating units 41 including a magnetron and a circuit to drive the magnetron; an airtight window 42; rectangular waveguides 43 to transmit microwaves of 2450 MHz each associated with the corresponding microwave oscillating unit 41; and horns 44 at leading ends of the waveguides 43 that are open ends to emit microwaves. The microwave generator 40 heats mainly a part of the packaged food PF that is relatively shallow in the half power depth using microwaves of 2450 MHz, i.e., a peripheral part of the packaged foods PF.

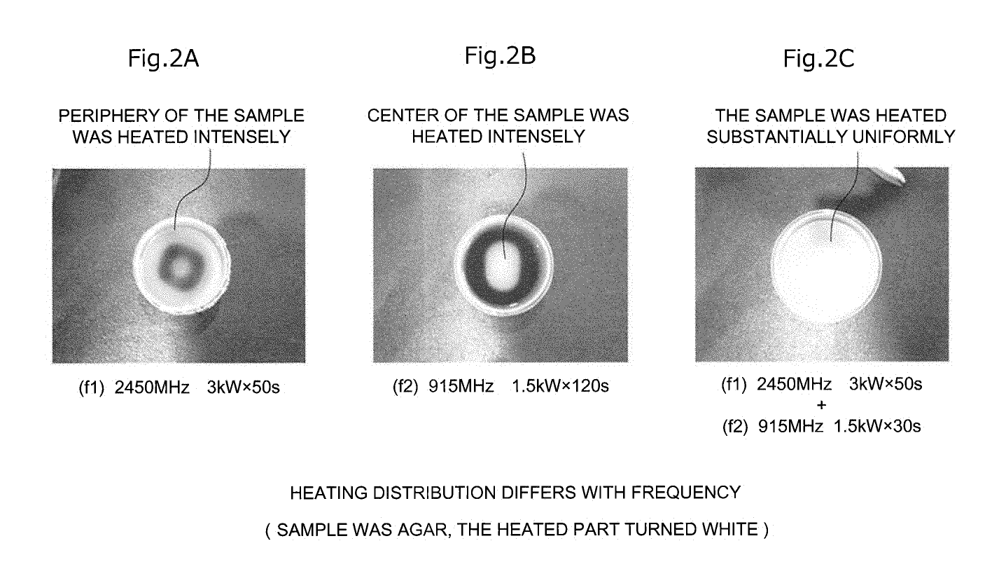

FIG. 2A, FIG. 2B, and FIG. 2C depict the depths of penetration. FIG. 2A, FIG. 2B, and FIG. 2C show the relationship between the frequency of microwaves and the half power depth. FIG. 2A shows heating at high frequency (e.g., 2450 MHz), FIG. 2B shows heating at low frequency (e.g., 915 MHz), and FIG. 2C shows heating at both a high frequency and a lower frequency. As shown in FIG. 2A, which shows a sample made of agar of 88 mm in diameter irradiated with microwaves of 2450 MHz, the half power depth is relatively shallow. The sample therefore is heated mainly at a peripheral part so that the part turns white. On the contrary, as shown in FIG. 2B, which shows a similar sample irradiated with microwaves of 915 MHz, the half power depth is relatively deep. The sample therefore is heated mainly at a center part.

When a sample is irradiated with microwaves of both of the frequencies, regardless of the order, then the sample is heated at both of the center and the peripheral parts, as shown in FIG. 2C. This shows uniform heating of the sample as a whole without undesirable temperature distribution. If the packaged food to be heated for sterilization is heated nonuniformly and a part of the packaged food does not reach the sterilization temperature, or if the duration to keep the sterilization temperature is insufficient, a small amount of bacteria may remain in the packaged food and the bacteria then may grow. Complete sterilization therefore is required for heat sterilization. In this way the advantageous effect of short-duration processing that effectively uses microwaves of two levels of high and low frequency and uniform heating are demanded for heat sterilization.

The microwave generator 40 includes one or a required number of the waveguides 43, and the waveguides 43 in the present embodiment apply microwaves toward packaged foods PF on the belt conveyor 20 from the below. The chamber for a heat sterilization process of the microwave generator 40 has the vertical dimension (e.g., a few hundreds mm) and the horizontal direction along the conveying direction (e.g., one thousand and a few hundreds mm) that are several times wider than 122 mm that is the free space wavelength of 2450 MHz. Such a wide chamber allows reflection or multiple reflection of microwaves at the side walls of the pressure vessel 10 or the partition plates 11 to implement multi-mode irradiation.

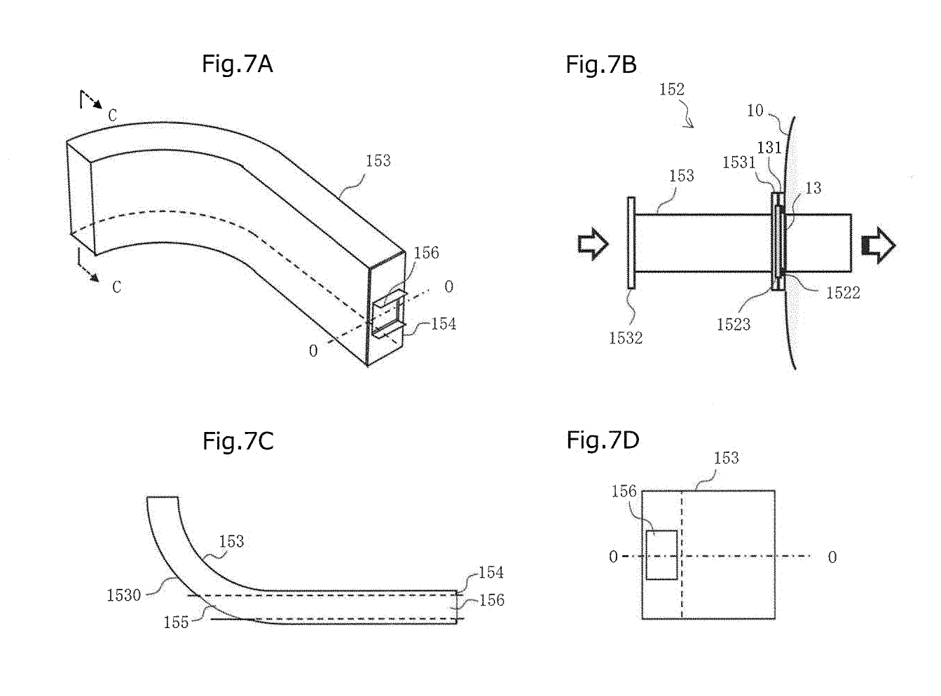

The microwave generator 40 also may have a stirrer 45 having a metal rotary fan (stirrer fan) at an appropriate position in the chamber for the heat sterilization process. Rotation of this fan stirs microwaves emitted from the horns 44 well in the chamber to increase the heat sterilization efficiency in the multi-mode. The windows 42 guide microwaves generated at the microwave oscillating unit 41 into the pressure vessel 10, and each window 42 is configured to let the waveguide pass through the pressure vessel 10, which will be described later with reference to FIG. 7B.

The microwave generator 50 applies microwaves of the second frequency that is lower than the first frequency, e.g., 915 MHz, to the packaged foods PF. The microwave generator 50 at least includes: an oscillator to oscillate microwaves of 915 MHz, e.g., a microwave oscillating unit 51 including a magnetron and a circuit to drive the magnetron; a rectangular waveguide 53 to transmit microwaves of 915 MHz; and a short-circuiting plate 54 as a short-circuiting member located at the downstream end of the waveguide 53. The microwave generator 50 heats mainly a center part of the packaged food PF that is relatively deep in the half power depth with microwaves of 915 MHz.

The waveguide 53 in the present embodiment penetrates through a window 52 and extends downward. The waveguide 53 then extends to the downstream via an ark-like bend that is bent at 90 degrees. The axial dimension of the waveguide 53 is set so that the short-circuiting plate 54 at the termination reflects microwaves and generates standing waves in the internal axial direction. The bent may have another shape other than the arc, and a relaying waveguide may join, which is inclined at a predetermined angle, e.g., at 45 degrees.

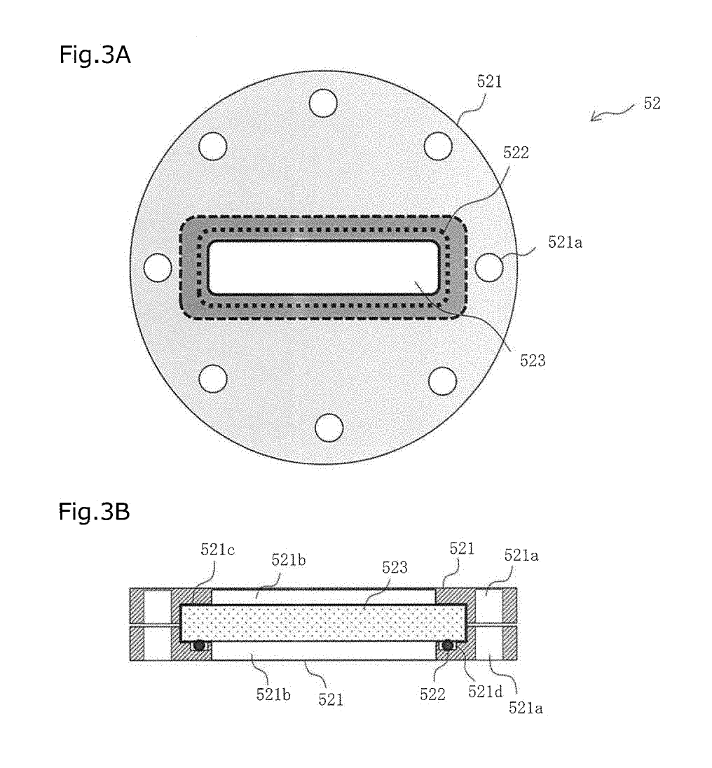

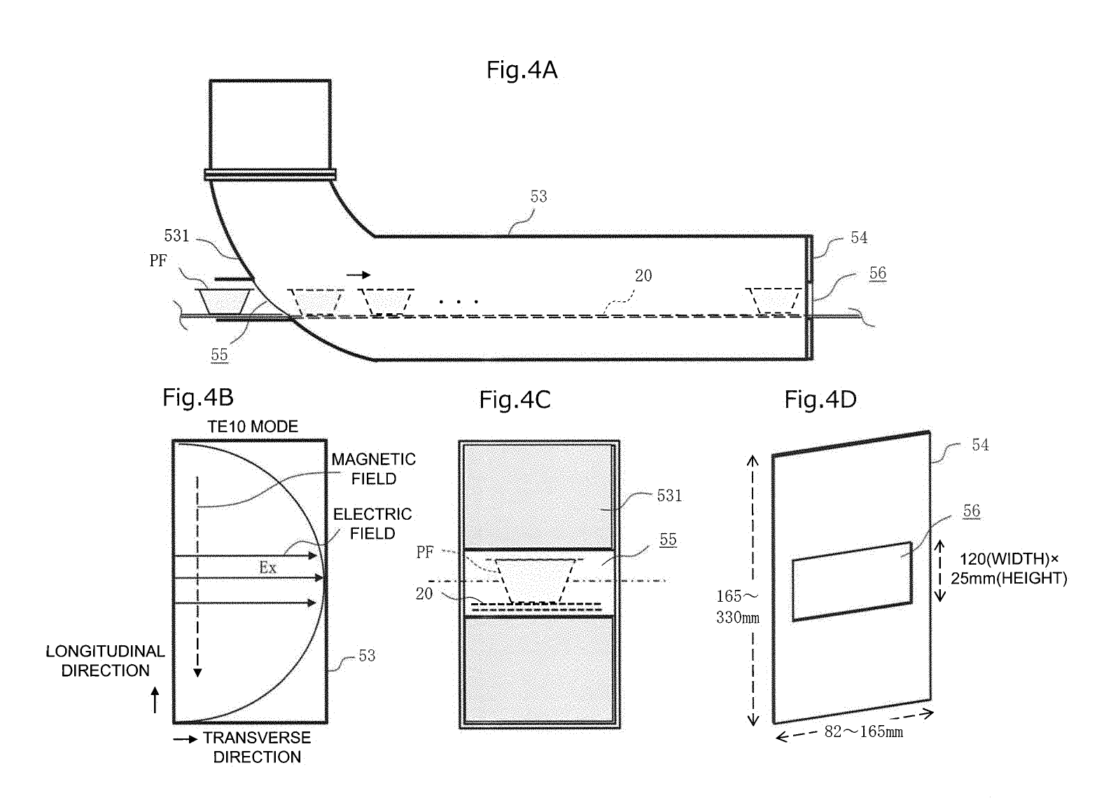

Referring to FIG. 3A and FIG. 3B, the following describes one example of the structure of the windows 42 and 52 that penetrate through the waveguides 43 and the waveguide 53, respectively. FIG. 3A and FIG. 3B describe one example of the structure of a window to guide the waveguide 53 into the pressure vessel 10, and FIG. 3A is a plan view and FIG. 3B is a vertical cross-sectional view. The waveguide 53 in FIG. 4A bends in the direction of the long sides of cross sections.

The window 52 includes a pair of round-pillar shaped metal flanges 521, 521, a packing 522 for airtightness, such as an O-ring, and a plate for dielectric shield 523 sandwiched between the pair of flanges 521 and 521. The flanges 521 as a pair each have a plurality of circumferentially equally-spaced fastening holes 521a on the periphery, and are fastened with fastening members, such as screws, at the fastening holes. The flanges 521 as a pair each have a through hole 521b that has the same shape as the cross section of the waveguide 53, and the through hole makes up a part of the waveguide.

The flanges 521 as a pair each also have a recess 521c on their opposed faces. The recesses 521c has a size slightly larger than the size of the through hole 521b. The recesses 521c receive the plate for dielectric shield 523 having a predetermined thickness while sandwiching the plate between the flanges. The plate for dielectric shield 523 is made of fluororesin, such as Teflon (registered trademark), which may be other materials having pressure resistance and microwave-transmissive property, such as polymethylpentene (TPX: registered trademark) and alumina. One of the flanges 521 has a groove 521d having a shape following the cross section of the waveguide 53, and this groove 521d receives the packing 522 inserted by press fitting.

FIG. 4A through FIG. 4D show the structure of one example of the waveguide to transmit microwaves in the low frequency range. FIG. 4A is a schematic side view of the waveguide. FIG. 4B shows the Poynting vector in the TE10 mode. FIG. 4C shows the waveguide of FIG. 4A viewed from the left. FIG. 4D is a perspective view of the short-circuiting plate.

FIG. 4D shows an example of the cross-sectional dimensions of the waveguide 53. In one example, the dimensions are 247.6 mm×123.8 mm for the long-sides and the short-sides, respectively. The waveguide 53 has openings 55 and 56 at the outer side face 531 of the bend (see FIG. 4A) and at the short-circuiting plate 54, respectively, that are mutually opposed, and these openings are to load and unload packaged foods PF (see FIG. 4C and FIG. 4D). The openings 55 and 56 have the same size. As shown in FIG. 4A, the dimensions of the openings 55 and 56 are set so that at least the belt conveyor 20 and the packaged foods PF on the belt conveyor 20 can pass through the openings.

As shown in FIG. 4B, electromagnetic waves have the electric field distribution Ex such that it has the largest intensity at the center in the long-side direction and has the smallest intensity at the upper and lower ends. The magnetic field distribution is orthogonal to the electric field. Although not shown in FIG. 4B, the distribution of the electric field intensity in the axial direction shows sin waves having the period of the free space wavelength. The packaged foods PF therefore may be arranged with pitches corresponding to the distribution of electric field intensity instead of continuously conveying at a constant speed. Alternatively, the packaged foods PF may be intermittently transferred so as to correspond to the pitch of the distribution of electric field intensity. Such arrangement or conveyance of the packaged foods enables effective heating of the packaged foods.

The openings 55 and 56 are located at a center part of the waveguide 53 in the long-side direction (in the height direction) of the cross section that has the largest electric-field intensity. The belt conveyor 20 is designed to move the packaged foods PF from the opening 55 to the opening 56 at the position corresponding to the height having the largest electric-field intensity. The chamber for the heat sterilization process of the microwave generator 50 has such a configuration of the waveguide 53, and so enables efficient microwave irradiation in a single-mode with standing waves of microwaves at 915 MHz inside of the waveguide. A single-mode irradiation does not require a wide multiple-reflection chamber that is necessary for multi-mode irradiation, and so the chamber can be made sufficiently compact. The cross-sectional dimensions of the waveguide 53 are not limited to 247.6 mm×123.8 mm that are typical dimensions for 915 MHz. As shown in FIG. 4D, the dimensions may be designed appropriately within the range of about 165 to 330 mm×about 82 to 165 mm and in the limit keeping the TE10 mode. Preferably the size of the waveguide 53 in the long-side direction of the cross section is the cutoff wavelength (free space wavelength/2) or more of the operating frequency (in this example, 915 MHz) and is the free space wavelength or less that transmits the basic mode TE10 only. The size may exceed the free space wavelength as long as the higher-order mode components generated are at a low level.

The temperature holding unit 60 keeps the temperature of the packaged foods that rises to the sterilization temperature at the microwave generators 40 and 50 for a predetermined duration to achieve reliable sterilization. The temperature holding unit 60 includes the units of a steam generation unit 61, a steam pipe 62 inside of the pressure vessel 10, and a fan 63 to send the surface heat of the steam pipe 62 into the chamber as hot air. These units may be disposed above and below the belt conveyor 20. The duration for keeping the temperature is set shorter for a higher inner temperature of the packaged foods PF. The average duration may be from one to a few minutes. The chamber of the temperature holding unit 60 may have a high-temperature steam atmosphere, or may have a high-temperature atmosphere by an electric heater to keep the packaged foods PF at high temperatures.

The cooling unit 70 cools the inside of the packaged foods PF after the temperature-holding processing to less than 100° C. before sending the packaged foods PF to the feeder 30. The cooling unit 70 includes a cold-water generating unit 71, a connector 72 penetrating through the pressure vessel 10, and a pipe 73. The lower end of the pipe 73 is directed downward above the belt conveyor 20 to spray or atomize cold water toward the packaged foods PF. The chamber of the cooling unit 70 may have a cold-air atmosphere, or the cooling unit 70 may be configured to immerse the packaged foods PF directly into a cold-water storage tank to cool the packaged foods PF. For the steam and the cooling water, water after use is removed from the cooling unit as needed, e.g., regularly or during a break period of the system.

A pressure adjusting unit 81 adjusts the pressure in the pressure vessel 10 using a not-illustrated pump, for example, so that the pressure through the connector 82 corresponds to or is equal to the saturation water vapor pressure at the sterilization temperature. The pressure adjusting unit automatically or manually adjusts the pressure using a temperature sensor or a pressure sensor, which are not illustrated. When the sterilization temperature is preset, the pressure may be set and controlled so as to correspond to the saturation water vapor pressure in the packaged foods PF at such a temperature. The air for pressurization may be compressed air that is heated close to the sterilization temperature.

The present embodiment includes a single belt conveyor 20 over the entire length of the pressure vessel 10. In another embodiment, the belt conveyor may be disposed separately for each chamber, or may be disposed separately for the microwave generators 40 and 50 and for the other chambers.

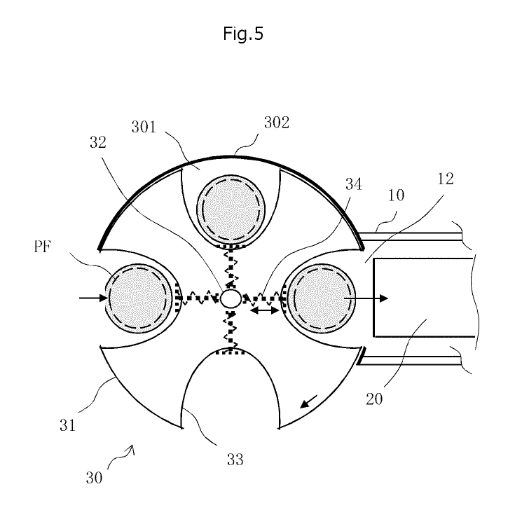

FIG. 5 is a schematic plan view of a rotary feeder that is one example the feeder 30. The feeder 30 loads and unloads the packaged foods PF to or from the pressure vessel 10, and may have various forms. The microwave-heating system may include the feeder 30 as needed. In one example, a rotary feeder described in JP-B-2885305 may be used as the feeder 30 of the present embodiment.

The feeder 30 has a base 301 having a flat upper face (see FIG. 1A), and includes a round-pillar shaped rotary unit 31 that is rotatably supported around a shaft 32 on the base 301. The dimension of the rotary unit 31 in the height direction is set equal to or higher than the height of the packaged foods PF. A part of the rotary unit 31 in the circumferential direction (on the right in FIG. 5) connects to an entrance 12 of the pressure vessel 10. The rotary unit 31 has one or a plurality of recesses 33 having the same shape (four recesses in the present embodiment) that are circumferentially equally-spaced on the periphery. Each recess 33 has a size to temporarily store the packaged foods PF, and has an arc-like shape, for example. The shape of the recesses 33 may correspond to the shape of the packaged foods PF, which may be elliptic, spindle-shaped or polygonal.

The feeder 30 has a slide-contact unit 302. This slide-contact unit 302 has a wall having the same radius of curvature as the circumference of the rotary unit 31, and the wall and the circumference of the rotary unit 31 are in slide-contact in a sealed manner. The slide-contact unit 302 keeps the recesses 33 storing the packaged foods PF airtight to the outside during the rotation of the rotary unit 31 immediately after the storage of the packaged foods PF in the recesses 33 and before facing the pressure vessel 10. The rotary unit 31 is rotated at a constant speed by a not-illustrated driving source, such as a motor, or is rotated intermittently with a predetermined angular pitch so as to oppose the recess 33 and the pressure vessel 10.

The feeder 30 includes an ejecting rod 34 between the shaft 32 and each recess 33. The ejecting rods 34 are disposed in a radially extended space in the rotary unit 31, and move forward and backward in the radial direction. These ejecting rods 34 eject the packaged foods PF toward the pressure vessel 10 to deliver the packaged foods PF to the pressure vessel 10. Each of the ejecting rods moves forward and backward relative to the corresponding recess 33 due to a compressive biasing force of a spiral spring and a mechanical force toward the radially outside against the compressive biasing force. The mechanical force may be implemented by a not-illustrated driving force so that the rod moves forward at the rotary position to face the pressure vessel 10. Alternatively, the ejecting rod of the rotary unit 31 may manually move forward and the rotary unit 31 also may manually rotate.

The rotary unit 31 may not have the ejecting rods 34. In one example, the rotary unit 31 may be inclined along the transferring direction of the packaged foods PF. When loading the packaged foods PF into the recesses 33, the packaged foods PF slide into the recesses 33 due to their weight along the inclination. To release the packaged foods PF for unloading, the packaged foods PF may slide due to their weight into the belt conveyor 20. In such a mode of moving and permitting the packaged foods to fall down due to their weight, the rotary unit may have a double-shutter mechanism so as to avoid communication between the outside air and the interior of the pressure vessel 10. The shutters are disposed upstream and downstream along the path to open alternately while moving the packaged foods intermittently.

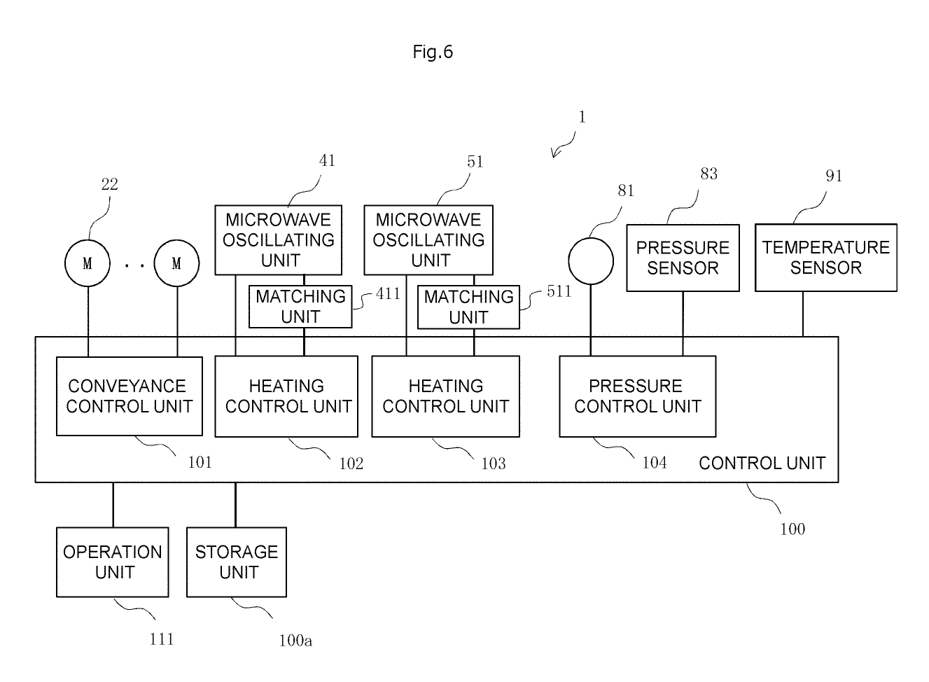

FIG. 6 is a block diagram showing one example of the microwave-heating system. The microwave-heating system 1 includes a control unit 100 including a computer to control the operation of the various units. The control unit 100 connects to a storage unit 100a and an externally manipulatable operation unit 111. The storage unit 100a stores an operation program to execute the heat sterilization processing and data necessary for the processing. The motors 22 are for conveyance, which include a motor to circulate the belt conveyor 20, a motor to drive the feeder 30, and other motors.

The computer of the control unit 100 executes the operation program based on the detection results of a pressure sensor 83 to detect the pressure in the pressure vessel 10 and a temperature sensor 91. The operation program then makes the control unit 100 function as a conveyance control unit 101 to control the driving of various motors for conveyance, a heating control unit 102 to control the irradiation with microwaves of frequency f1, a heating control unit 103 to control the irradiation with microwaves of frequency f2, a pressure control unit 104 to adjust the air pressure in the pressure vessel 10, and a not-illustrated internal timer for timekeeping. The heating control unit 102 and the heating control unit 103 operate under preset heating conditions depending on the types of an article to be heat-sterilized, for example.

Matching units 411 and 511 each include a detection circuit to electrically detect an impedance change. These matching units 411 and 511 perform matching to cope with an impedance change in accordance with the heating states of the packaged foods PF and an impedance change resulting from mismatching in the microwave circuit, such as the waveguide, from the microwave oscillating units 41, 51 to the irradiation end of microwaves.

Each chamber in the pressure vessel 10 may have a length in the conveyance direction while considering the processing time as well as the set conveyance speed of the belt conveyor 20. In the embodiment having the separate belt conveyor 20 for each chamber, the length of the chamber can be set appropriately while adjusting the processing time or adjusting the conveyance speed of the belt conveyor 20 of each chamber.

The above-stated embodiment describes the waveguide 53 that bends in the direction of the long sides of the cross sections as shown in FIG. 1A and FIG. 4A. FIG. 7A through FIG. 7D show another example of the waveguide that bends in the direction of the side faces of the cross sections. In FIG. 7A through FIG. 7D, FIG. 7A is a schematic perspective view of the waveguide at a part in the pressure vessel, FIG. 7B shows one example of the window to guide the waveguide into the pressure vessel, FIG. 7C shows the waveguide along the longitudinal direction, and FIG. 7D is a view taken along the arrow C-C of FIG. 7A.

As shown in FIG. 7A, the low-frequency range waveguide 153 has the long sides oriented vertically, and bends along a horizontal plane. This structure can reduce the radius of curvature at the bend as compared with the structure of FIG. 4A, and so the waveguide is compact. As shown in FIG. 7C and FIG. 7D, the waveguide has an opening 155 at the bend on the outer circumference 1530 and has an opening 156 at a short-circuiting plate 154. As shown in FIG. 7A and FIG. 7D, these openings 155 and 156 have predetermined dimensions relative to the center line O-O in the long-side direction of the cross section. Preferably each opening has a vertically equal dimension of the upper part and the lower part relative to the center line O-O.

FIG. 7B shows one example of the window 152 of the waveguide 153. The window 152 has basically the same structure as the structure of FIG. 3B. The window 42 also may have a similar structure. The embodiment shown in FIG. 1A and FIG. 4A also may have a similar structure.

The window 152 includes a hole 13 at an appropriate position of the pressure vessel 10 and an annular metal flange 131 that surrounds the hole 13 at an appropriate position of the pressure vessel 10. The metal flange 131 is welded, for example, to the outer face of the pressure vessel 10. The window 152 also includes metal flanges 1531 and 1532 at both ends of the waveguide 153, and a plate for dielectric shield 1523 sandwiched between the metal flanges 131 and 1531. The plate for dielectric shield 1523 has a microwave-transmissive property, and may be made of above-stated fluororesin. The metal flanges 1531 and 1532 have a hole having the same shape as the cross section of the waveguide 153. These metal flanges 131 and 1531 are joined by pressure welding, so that the plate for dielectric shield 1523 is disposed between these flanges over the entire cross section of the waveguide 153. The window has an annular groove between the plate for dielectric shield 1523 and the metal flange 131, and this groove receives a packing 1522 inserted by press fitting. This structure enables transmission of microwaves through the waveguide 153 and achieves airtightness between the inside and the outside of the pressure vessel 10.

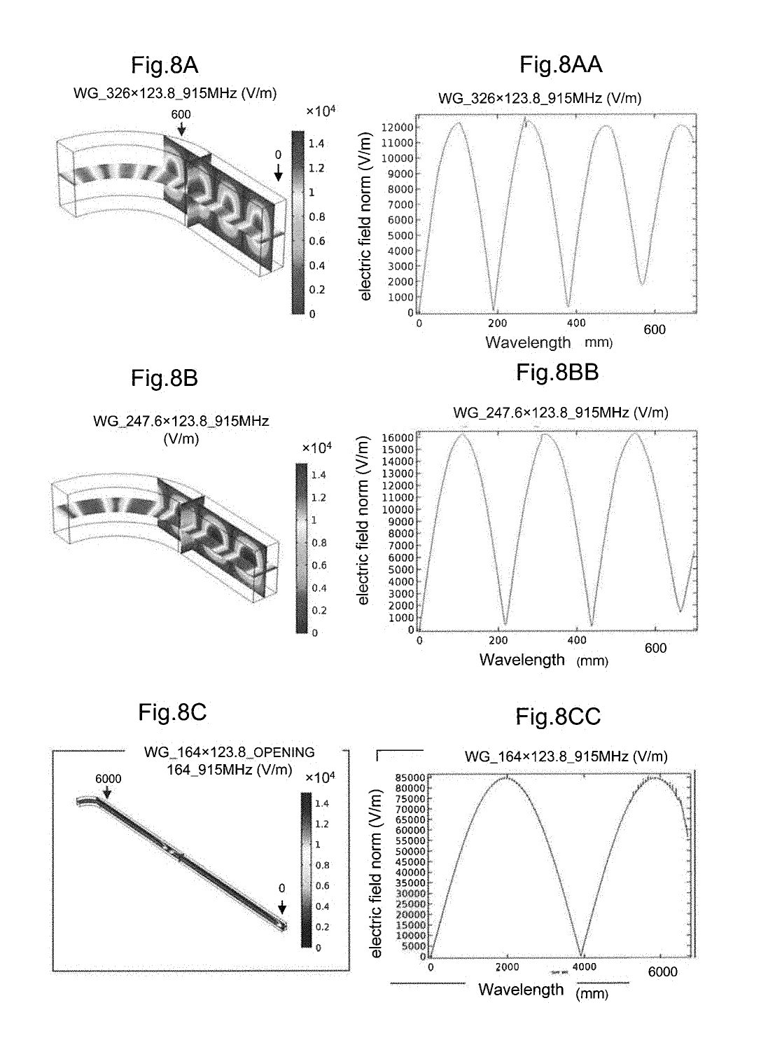

FIG. 8A to FIG. 8CC show the test results indicating the relationship between large, medium, and small dimensions of the long sides of the cross section of the waveguide at 915 MHz in the low frequency range, and the electric field intensity of standing waves when the waveguides do not have openings.

FIG. 8A shows a large dimension, i.e., 326 mm (corresponding to the free space wavelength λo). In this case, the largest electric field intensity is 13000 (V/m) as shown in FIG. 8AA.

FIG. 8B shows a medium dimension, i.e., 247.6 mm (corresponding to the intermediate standard “WRI-9” between λo/2 and λo). In this case, the largest electric field intensity is 16000 (V/m) as shown in FIG. 8BB.

FIG. 8C shows a small dimension, i.e., 164 mm (corresponding to ½ of λo). In this case, since the distance between the opposed walls is short, the largest electric field intensity is high up to 85000 (V/m) as shown in FIG. 8CC. This case reaches the generation limit of the basic mode at 915 MHz, and the wavelength is 4000 (mm).

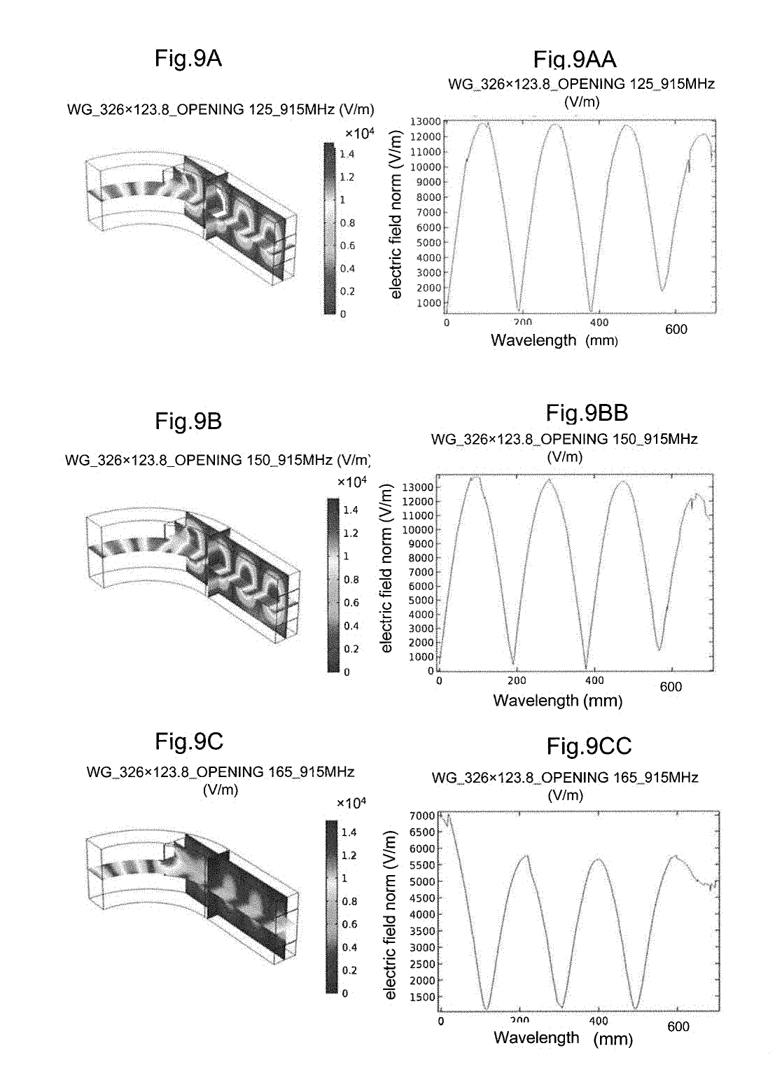

The following considers the ratio of the electric field intensity of the test results for the waveguides having the openings shown in FIG. 9A to FIG. 12CC to the electric field intensity of the waveguides without openings as shown in FIG. 8A, FIG. 8B and FIG. 8C. The input power is the same for the tests. The openings of these drawings have a vertically equal dimension of the upper part and the lower part relative to the center line O-O.

FIG. 9A to FIG. 9CC show the waveguides having large dimensions in the long-side direction of the cross section at 915 MHz in the low frequency range. These drawings show the test results indicating the relationship between the dimension of the openings in that direction and the electric field intensity of standing waves.

FIG. 9A shows the opening of 125 mm. In this case, the largest electric field intensity is 13000 (V/m) as shown in FIG. 9AA. That is, a comparison with the waveguide without openings shows 13000 (V/m)/13000 (V/m), meaning that the ratio is substantially 100%.

FIG. 9B shows the opening of 150 mm. In this case, the largest electric field intensity is 13000 (V/m) as shown in FIG. 9BB. That is, a comparison with the waveguide without openings shows 13000 (V/m)/13000 (V/m), meaning that the ratio is substantially 100%.

FIG. 9C shows the opening of 165 mm. In this case, the largest electric field intensity is 5500 (V/m) as shown in FIG. 9CC. That is, a comparison with the waveguide without openings shows 5500 (V/m)/13000 (V/m), meaning that the ratio is an unfavorable result of 42%.

From the viewpoint of efficient heating in the single-mode, the opening preferably has the dimensions corresponding to the largest electric field intensity of 100 to 50% of the intensity of the waveguide without openings. When openings of 150 mm are formed in the waveguide having the long-side dimensions of 326 mm, the ratio of the largest electric field intensity is substantially 100%. Such a structure therefore can be used for relatively bulky packaged foods PF.

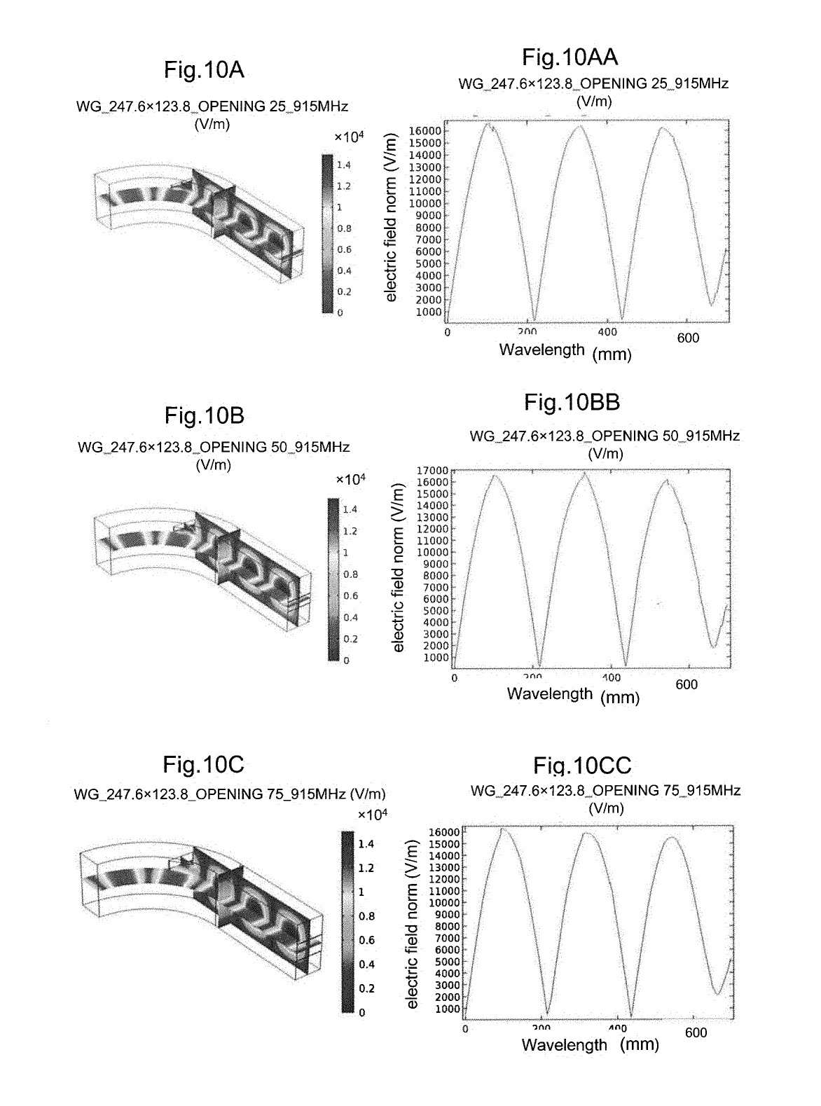

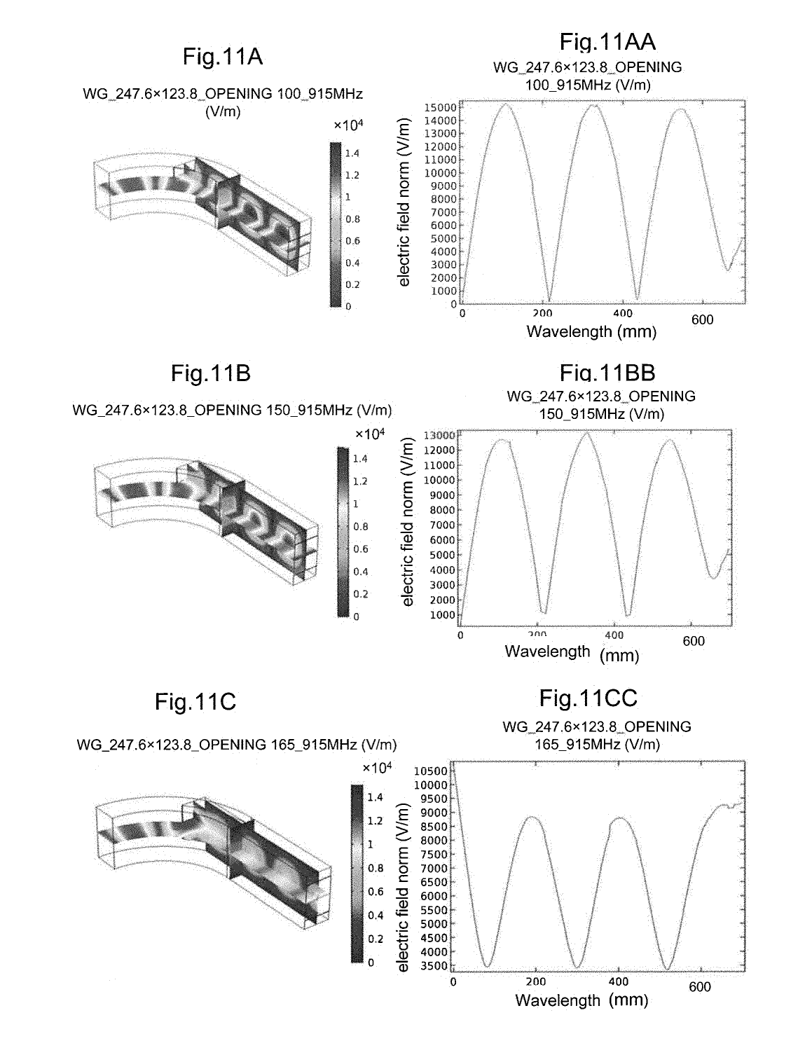

FIG. 10A to FIG. 10CC and FIG. 11A to FIG. 11CC show the waveguides having middle dimensions in the long-side direction of the cross section at 915 MHz in the low frequency range. These drawings show the test results indicating the relationship between the dimension of the openings in that direction and the electric field intensity of standing waves.

FIG. 10A shows the opening of 25 mm. In this case, the largest electric field intensity is 16000 (V/m) as shown in FIG. 10AA. That is, a comparison with the waveguide without openings shows 16000 (V/m)/16000 (V/m), meaning that the ratio is substantially 100%.

FIG. 10B shows the opening of 50 mm. In this case, the largest electric field intensity is 16000 (V/m) as shown in FIG. 10BB. That is, a comparison with the waveguide without openings shows 16000 (V/m)/16000 (V/m), meaning that the ratio is substantially 100%.

FIG. 10C shows the opening of 75 mm. In this case, the largest electric field intensity is 16000 (V/m) as shown in FIG. 10CC. That is, a comparison with the waveguide without openings shows 16000 (V/m)/16000 (V/m), meaning that the ratio is substantially 100%.

FIG. 11A shows the opening of 100 mm. In this case, the largest electric field intensity is 15000 (V/m) as shown in FIG. 11AA. That is, a comparison with the waveguide without openings shows 15000 (V/m)/16000 (V/m), meaning that the ratio is 94%.

FIG. 11B shows the opening of 150 mm. In this case, the largest electric field intensity is 13000 (V/m) as shown in FIG. 11BB. That is, a comparison with the waveguide without openings shows 13000 (V/m)/16000 (V/m), meaning that the ratio is 81%.

FIG. 11C shows the opening of 165 mm. In this case, the largest electric field intensity is 9000 (V/m) as shown in FIG. 11CC. That is, a comparison with the waveguide without openings shows 9000 (V/m)/16000 (V/m), meaning that the ratio is 56%.

When openings of 150 mm are formed in the waveguide having the long-side dimensions of 247.6 mm, the ratio of the largest electric field intensity is 81%. Such a structure therefore can be used for relatively bulky packaged foods PF. As shown in FIG. 11CC, when openings of 165 mm are formed in the waveguide having the long-side dimensions of 247.6 mm, the ratio of the largest electric field intensity is still 56%, i.e., more than 50%. Such a structure also therefore can be used for bulkier packaged foods PF.

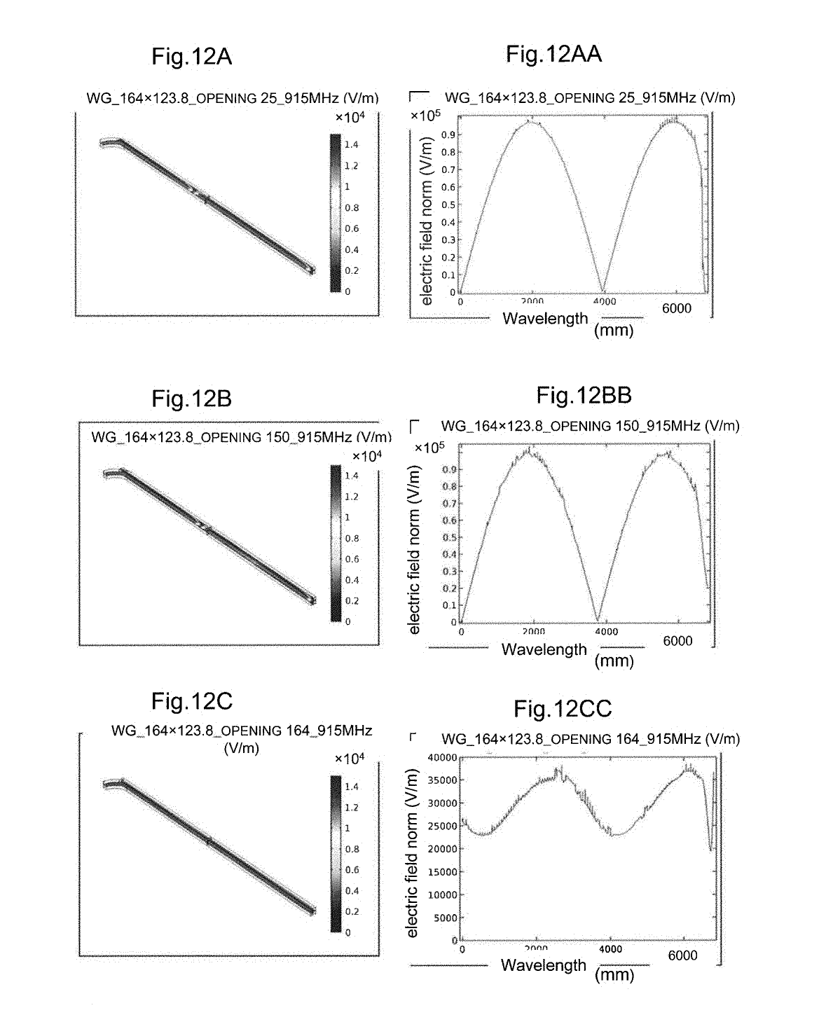

FIG. 12A to FIG. 12CC show the waveguides having small dimensions in the long-side direction of the cross section at 915 MHz in the low frequency range. These drawings show the test results indicating the relationship between the dimension of the openings in that direction and the electric field intensity of standing waves.

FIG. 12A shows the opening of 25 mm. In this case, the ratio of the largest electric field intensity is about 90% as shown in FIG. 12AA.

FIG. 12B shows the opening of 150 mm. In this case, the ratio of the largest electric field intensity is about 90% as shown in FIG. 12BB.

FIG. 12C shows the opening of 164 mm, i.e., the full-open state. In this case, the largest electric field intensity is 35000 (V/m) as shown in FIG. 12CC. A comparison with the waveguide without openings shows 35000 (V/m)/85000 (V/m), and so the ratio decreases to 41%.

In this way, FIG. 12A to FIG. 12CC show that the openings can have dimensions (150 mm) close to substantially full-open of the waveguide. Since the electric field intensity is high, the heating effect also is high. On the contrary, the wavelength is long, and so the system will be large for effective heating using a plurality of peaks of the electric field.

The present embodiment performs heating by irradiation with microwaves of the first frequency, followed by irradiation with microwaves of the second frequency. The order of irradiation may be reversed. The first and second frequency is not limited to 2450 MHz and 915 MHz as long as the frequency has the relationship of the second frequency<the first frequency so that a difference in half power depth can be used. In another embodiment, the openings 55, 56 (openings 155, 156) may be formed at at least one part. In this case, packaged foods PF may reciprocate between such an opening and the interior of the waveguide 53 for similar heating treatment.

The present embodiment describes a non-limiting example of microwave-heating in the pressure vessel. The microwave-heating may be performed to an article in package that is strong and does not break with a certain pressure or to each article stored in a retainer or a plastic container. The present embodiment describes a non-limiting example of the heat sterilization system, and the present embodiment may be used for general heating processing for various purposes other than foods.

Next the following describes one example of a process for manufacturing packaged foods. A round tray-type molded container was prepared, which was made of plastic and was of 88 mm in diameter and 35 mm in internal depth at the center. The container had a flange on the outer rim of the opening. The container was filled with 100 g of commercially prepared chikuzen-ni (or braised chicken and vegetable). Next a plastic lid was placed over the entire flange from the above, and the lid on the flange was heated to melt so that the lid adhered to the flange to hermetically seal the inside. In this way, packaged chikuzen-ni was prepared.

This packaged chikuzen-ni was heat-sterilized by the microwave-heating system 1 described herein. Specifically, the packaged chikuzen-ni was allowed to pass through the microwave generator 40 and the microwave generator 50 for the first microwave irradiation process and the second microwave irradiation process, to increase the temperature of the packaged chikuzen-ni to 121° C. Next, the packaged chikuzen-ni was transferred to the temperature holding unit 60 to keep the packaged chikuzen-ni there for 4 minutes, followed by cooling at the cooling unit 70.

Through the process, the inside of the packaged chikuzen-ni was sufficiently sterilized.

The microwave-heating system in the embodiment as stated above applies microwaves to a sealed packaged article for heating. The microwave-heating system includes a first microwave generator to irradiate the article with microwaves of a first frequency in a multi-mode and a second microwave generator to irradiate the article with microwaves of a second frequency in a single-mode, the second frequency being lower than the first frequency.

The microwave-heating process in the embodiment as stated above applies microwaves to a sealed packaged article for heating. The microwave-heating process includes a first microwave irradiation process of irradiating the article with microwaves of a first frequency in a multi-mode and a second microwave irradiation process of irradiating the article with microwaves of a second frequency in a single-mode, the second frequency being lower than the first frequency.

The process for manufacturing packaged foods in the embodiment as stated above includes a heat sterilization process under pressure of applying microwaves to sealed packaged foods for heat sterilization. The heat sterilization process under pressure includes a first microwave irradiation process of irradiating the packaged foods with microwaves of a first frequency in a multi-mode and a second microwave irradiation process of irradiating the packaged foods with microwaves of a second frequency in a single-mode, the second frequency being lower than the first frequency.

These embodiments irradiate the sealed packaged article with microwaves of a first frequency in a multi-mode and irradiate the sealed packaged article with microwaves of a second frequency lower than the first frequency in a single-mode. Such irradiation with microwaves of the first and the second frequency rapidly heat different parts of the article corresponding to the different half power depths, and so implements uniform heating of the entire article without undesirable temperature distribution. The irradiation with microwaves of the second frequency having a longer wavelength in a single-mode in the waveguide makes the structure compact and efficient as compared with the structure in a multi-mode.

The microwave-heating system in the embodiment as stated above includes a pressure vessel having a chamber to store the article, and a pressuring unit to pressurize the chamber in the pressure vessel to one atmospheric pressure or higher. The pressure vessel includes a first irradiation chamber that stores the first microwave generator and a second irradiation chamber that includes the second microwave generator. This configuration pressurizes the first irradiation chamber and the second irradiation chamber at 1 atmospheric pressure or higher, i.e., the pressure substantially equal to the saturation water vapor pressure at the increased temperature inside of the sealed packaged article by heating. The package therefore does not rupture or break when the inner pressure of the package increases by heating.

In the above-stated embodiment, the first irradiation chamber has a space that is wider than the free space wavelength corresponding to the first frequency and is surrounded with metal walls that cause multiple reflection of microwaves, and the second irradiation chamber has a space in the waveguide that forms standing waves of the second frequency. With this configuration, multiple reflection is easily generated in the first irradiation chamber for efficient multi-mode irradiation. The second irradiation chamber enables single-mode irradiation in the waveguide.

In the above-stated embodiment, the waveguide making up the second irradiation chamber includes a bend at a part along the axial direction, and a short-circuiting plate disposed at a downstream end that is downstream of the bend in the axial direction. The waveguide includes an opening at at least one of the wall of the bend on the outer circumference and of the short-circuiting plate, and at a center part in the long-side direction of the cross section of the waveguide. With this configuration, the article is loaded or unloaded via the opening, and so the interior of the waveguide from the bend to the downstream end that is downstream of the bend serves as the second irradiation chamber. The opening is disposed at a center part in the long-side direction of the cross section of the waveguide, and so the article can be located at an area selected to have the largest electric field intensity, and can be heated effectively.

In the embodiment as stated above, the dimension of the opening in the longitudinal direction is preferably such that the electric field intensity in such a waveguide is 100% to 50% of the electric field intensity generated in the waveguide without openings. This configuration achieves the electric field intensity that is at least 50% of the waveguide without openings, and so keeps efficient heating processing of the article.

In the above-stated embodiment, the second irradiation chamber includes a conveyor to convey the article via the opening and in the waveguide along the axial direction. This configuration automatically conveys the article in the second irradiation chamber.

In the above-stated embodiment, the first microwave generator includes a plurality of microwave irradiation ports. This configuration increases the efficiency of multi-mode irradiation by multiple reflection.

In the above-stated embodiment, the first and second microwave generators each connect to a waveguide to transmit microwaves via a side wall of the pressure vessel. The waveguide has a window that shields between the inside and the outside of the pressure vessel. The window includes a plate for dielectric shield, and the plate for dielectric shield is made of fluororesin. With this configuration, microwaves transmit well through the fluororesin as compared with through reinforced glass, and so the plate for dielectric shield transmits microwaves to the inside reliably for irradiation.

In the above-stated embodiment, the microwave-heating system includes a control unit to control the first and second microwave generator to operate in sequence. With this configuration, irradiation with microwaves is performed not simultaneously but in the order of the first and the second microwaves. The order may be reversed.

In the above-stated embodiment, the second microwave irradiation process is performed in the space in the waveguide that forms standing waves of the second frequency, and the space is defined by extending a center part in the long-side direction of a cross section of the waveguide in the axial direction of the waveguide. This configuration allows the article to be located at a space selected having the largest electric field intensity, and so enables efficient heating.

In the above-stated embodiment, the process for manufacturing packaged foods heat-sterilizes the packaged foods by the above-stated microwave-heating system or microwave-heating process.

The process for manufacturing packaged foods firstly performs a filling process of filling a container with foods and hermetically sealing the container. After this filling process, the foods are in the packaged foods. In one example, when the container is a molded container including a body and a lid, the process firstly fills the body with foods, and then places the lid over the body and hermetically seals the container to prepare packaged foods. When the container is a bag, such as a flat bag or a standing pouch, the packaging may be pillow-type packaging. Forms of the container include any shapes, such as a bag, a plate, a bowl, a small bowl, and a container with base (e.g., a wineglass). Preferably the container is made of a microwave-transmissive material as stated above. In this case, the material of the container preferably has airtightness as well as a light-shielding effect. Preferably when the container includes a body and a lid, the lid also is made of a microwave-transmissive material.

Next the process performs a heat sterilization process under pressure to the packaged foods subjected to the filling process. The heat sterilization process under pressure is performed while irradiating with microwaves. This heat sterilization process under pressure includes the first microwave irradiation process and the second microwave irradiation process as stated above. The heat sterilization process under pressure further may include a heating method other than by irradiation with microwaves. In one example, the process additionally includes a pre-heating process to preheat packaged foods by steam or warm water before the first microwave irradiation process.

As preferable conditions of the heat sterilization process under pressure, the center part of the packaged foods is heated at the temperature of 120° C. for 4 minutes when the foods have the pH of 4.6 or higher and the water activity of 0.94 or higher. The heating may have the effect equal to or more of this condition.

After the heat sterilization process under pressure, the process performs a cooling process to cool the packaged foods. Foods that can be used for the above process include any foods, such as a main dish, side dish, delicatessen, staple foods, jelly, and drinks. Examples of the foods include curry sauce, hashed sauce, pasta sauce, seasoning for Chinese-style dishes, such as Mapo doufu, seasoning for mixed rice, seasoning for rice-bowl dishes, stew, soup, Japanese-style soup, porridge, cooked rice, zenzai (or sweet red bean soup), hamburgers, meatballs, seasoned meat, meat in oil, seasoned fish meat, and fish meat in oil.

Packaged foods manufactured by the process for manufacturing packaged foods described herein may be any packaged foods. Particularly, packaged foods for elderly people are preferable, including nursing case foods, liquid foods, special foods for clinical condition, nutritional supplement foods, thickened foods for dysphagia, and functional foods.

The systems and processes described herein heat an article with microwaves in the low frequency range in a single-mode so as to avoid an increase of the system in size and achieve uniform heating and high heating efficiency.

The embodiments as stated above may be combined.

The above description is to be considered in all respects as illustrative and not restrictive. The technical scope of the present invention is defined by the claims, and is intended to include any modification within the meaning and scope equivalent to the terms of the claims.

What is claimed is:

1. A microwave-heating system to irradiate a sealed packaged article with microwaves for heating, the system comprising.
a first microwave generator to irradiate the article with microwaves of a first frequency in a multi-mode; and
a second microwave generator to irradiate the article with microwaves of a second frequency in a single-mode, the second frequency being lower than the first frequency.

2. The microwave-heating system according to claim 1, further comprising:
a pressure vessel having a chamber to store the article; and
a pressurizing unit to pressurize the chamber in the pressure vessel to 1 atmospheric pressure or higher;
wherein the pressure vessel includes a first irradiation chamber that stores the first microwave generator and a second irradiation chamber that includes the second microwave generator.

3. The microwave-heating system according to claim 2, wherein:
the first irradiation chamber has a space that is wider than a free space wavelength corresponding to the first frequency and is surrounded with metal walls that cause multiple reflection of microwaves of the first frequency; and
the second irradiation chamber has a waveguide defining a space that forms standing waves of microwaves of the second frequency.

4. The microwave-heating system according to claim 3, wherein:
said waveguide has an axial direction and includes a bend at a part along the axial direction, and further includes a short-circuiting plate disposed at an end axially downstream of the bend; and
said waveguide includes an opening at at least one of
a wall of the bend on an outer circumference, and
the short-circuiting plate, and
at a center part in a long-side direction of a cross section of the waveguide.

5. The microwave-heating system according to claim 4, wherein the opening in the longitudinal direction has a dimension such that electric field intensity in the waveguide is 100% to 50% of an electric field intensity generated in the waveguide without openings.

6. The microwave-heating system according to claim 4, wherein the second irradiation chamber includes a conveyor to convey the article via the opening and in the waveguide along the axial direction.

7. The microwave-heating system according to claim 2, wherein the first microwave generator includes a plurality of microwave irradiation ports.

8. The microwave-heating system according to claim 7, wherein the first and second microwave generators each connect to a waveguide to transmit microwaves via a side wall of the pressure vessel, the waveguide has a window that shields between the inside and the outside of the pressure vessel, and the window includes a dielectric shield plate made of fluororesin.

9. The microwave-heating system according to claim 1, further comprising a control unit to control the first and second microwave generators to operate in sequence.

10. A microwave-heating process that applies microwaves to a sealed packaged article for heating, the process comprising:
a first microwave irradiation process, comprising irradiating the article with microwaves of a first frequency in a multi-mode; and
a second microwave irradiation process, comprising irradiating the article with microwaves of a second frequency in a single-mode, the second frequency being lower than the first frequency.

11. The microwave-heating process according to claim 10, wherein the second microwave irradiation process is performed in a space in a waveguide that forms standing waves of the second frequency.

12. A process for manufacturing packaged foods, the process comprising a heat sterilization process including applying microwaves to sealed packaged foods for heat sterilization, wherein the heat sterilization process includes:
a first microwave irradiation process, comprising irradiating the packaged foods with microwaves of a first frequency in a multi-mode; and
a second microwave irradiation process, comprising irradiating the packaged foods with microwaves of a second frequency in a single-mode, the second frequency being lower than the first frequency.

13. The process for manufacturing packaged foods according to claim 12, wherein the second microwave irradiation process is performed in a space in a waveguide that forms standing waves of the second frequency, and the space is defined by extending a center part in a long-side direction of a cross section of the waveguide in the axial direction of the waveguide.
